(19) United States
(12) Patent Application Publication
(10) Pub. No.: US 2013/0017926 A1
(43) Pub. Date: Jan. 17, 2013

(54) CRANKING TORQUE CONTROL APPARATUS

(71) Applicants: Koji Miwa, Susono-shi (JP); Takashi Kawai, Gotemba-shi (JP)

(72) Inventors: Koji Miwa, Susono-shi (JP); Takashi Kawai, Gotemba-shi (JP)

(73) Assignee: TOYOTA JIDOSHA KABUSHIKI KAISHA, Toyota-shi, Aichi (JP)

(21) Appl. No.: 13/520,309

(22) PCT Filed: May 18, 2011
(86) PCT No.: PCT/JP2011/061408

§ 371 Date: Jul. 2, 2012

(51) Int. Cl. B60W 10/08

(52) U.S. Cl. 477/3; 180/65.285; 903/930

(57) ABSTRACT

A cranking torque control apparatus (100) is mounted on a hybrid vehicle (1) provided with: an engine (11); a motor (MG1) coupled with the engine and capable of cranking the engine; and a battery (21) capable of supplying electric power to the motor. The cranking torque control apparatus is provided with: a correcting device (22) for estimating a fluctuation amount of power consumption caused by a rotational fluctuation of the engine when the motor cranks the engine and for correcting an upper limit of outputtable electric power of the battery in accordance with the estimated fluctuation amount.

### TECHNICAL FIELD

The present invention relates to a cranking torque control apparatus for controlling cranking torque of a motor when an engine is cranked by the motor in a vehicle provided with the engine and the motor, such as, for example, a hybrid car.

### BACKGROUND ART

As this type of apparatus, for example, there has been suggested an apparatus for performing smoothing on an electric power deviation, calculated by subtracting assumed electric power inputted to or outputted from the motor, from input/output electric power inputted to or outputted from a battery, and for setting an input/output allowable limit on the basis of the electric power deviation and an input/output limit of the battery, in order to suppress charge and discharge by excessive electric power of the battery (refer to a patent document 1).

Alternatively, there has been suggested an apparatus for driving a motor generator to crank the engine when receiving a change demand from an electric vehicle (EV) driving mode to a hybrid vehicle (HV) driving mode. Here, in particular, the following is described; namely, discharge allowable electric power is derived such that a direct current voltage of the battery does not fall below a lower limit voltage, and a torque command value is adjusted such that consumption power of the motor generator does not exceed the discharge allowable power. It is also described that the lower limit voltage is temporarily increased if an accelerator opening degree reaches a predetermined reference value within a predetermined time after the demand to change to the HV driving mode (refer to a patent document 2).

### PRIOR ART DOCUMENT

### Patent Document

Patent document 1: Japanese Patent Application Laid Open No. 2006-094691
Patent document 2: Japanese Patent Application Laid Open No. 2009-166513

### DISCLOSURE OF INVENTION

### Subject to be Solved by the Invention

In the aforementioned background art, if a remaining battery amount (or state of charge of the battery) falls below a lower limit, for example, in cases where the remaining battery amount is relatively low, in cases where an engine temperature is relatively low, or in similar cases, then, the protection of the battery is prioritized, resulting in unexpected engine stall, which is technically problematic.

In view of the aforementioned problems, it is therefore an object of the present invention to provide a cranking torque control apparatus capable of suppressing the occurrence of the unexpected engine stall while preventing the voltage of the battery from falling below the lower limit voltage of the battery.

### Subject to be Solved by the Invention

The cranking torque control apparatus of the present invention, in order to achieve the above object of the present invention, mounted on a hybrid vehicle comprising: an engine; a motor coupled with the engine and capable of cranking the engine; and a battery capable of supplying electric power to the motor, said cranking torque control apparatus provided with: a correcting device for estimating a fluctuation amount of power consumption caused by a rotational fluctuation of the engine when the motor cranks the engine and for correcting an upper limit of outputtable electric power of the battery in accordance with the estimated fluctuation amount.

According to the cranking torque control apparatus of the present invention, the cranking torque control apparatus is mounted on the hybrid vehicle provided with: the engine; the motor coupled with the engine and capable of cranking the engine; and the battery capable of supplying the electric power to the motor. Here, the “motor” means a motor for controlling the engine but may mean a motor realized in a motor generator. In other words, as long as it can function as a motor, the “motor” may mean a motor generator.

The correcting device, which is provided with, for example, a memory, a processor, and the like, estimates the fluctuation amount of the power consumption caused by the rotational fluctuation of the engine when the motor cranks the engine (i.e. at the start of the engine) and corrects the upper limit of the outputtable electric power of the battery in accordance with the estimated fluctuation amount. Here, the “fluctuation amount of the power consumption caused by the rotational fluctuation of the engine” mainly means a fluctuation amount of power consumption caused by a rotational fluctuation when an engine revolution or the number of engine revolutions passes a resonance revolution band.

According to studies of the present inventors, the following matter has been found; namely, if the voltage of the battery falls below a lower limit voltage value set in advance, that possibly causes rapid deterioration of the battery. Thus, in order to prevent the voltage of the battery from falling below the lower limit voltage, the electric power outputted from the battery is limited in many cases. Then, the limitation of the output electric power of the battery causes a reduction in cranking torque of the motor. As a result, the engine revolution decreases with the reduction in the support torque, which possibly leads to the unexpected engine stall. The possibility is high in the resonance revolution band in which the variation in the engine revolution is relatively large.

Thus, in the present invention, as described above, by virtue of the correcting device, the fluctuation amount of the power consumption caused by the rotational fluctuation of the engine is estimated when the motor cranks the engine, and the upper limit of the outputtable electric power of the battery is corrected in accordance with the estimated fluctuation amount. Specifically, for example, the upper limit of the outputtable electric power of the battery is corrected by the correcting device so as to have a margin according to the fluctuation amount of the power consumption caused by the rotational fluctuation of the engine.

Thus, for example, even if the engine revolution varies due to the resonance revolution band, it is possible to prevent the voltage of the battery from falling below the lower limit voltage and to suppress the occurrence of the unexpected engine stall.

The operation and other advantages of the present invention will become more apparent from an embodiment explained below.

### BRIEF DESCRIPTION OF DRAWINGS

FIG. 1 is a schematic diagram showing a configuration of a hybrid vehicle in an embodiment of the present invention

FIG. 2 is a flowchart showing cranking torque control processing in the embodiment of the present invention.

FIG. 3(a) shows one example of a relation among state of charge of a battery, a battery temperature, and outputtable electric power, and FIG. 3(b) shows a relation between an engine temperature and required cranking torque.

FIG. 4 shows one example of a time variation such as an engine revolution in a comparative example.

FIG. 5 shows one example of the time variation such as an engine revolution in the embodiment of the present invention.

### MODE FOR CARRYING OUT THE INVENTION

Hereinafter, an embodiment of the cranking torque control apparatus of the present invention will be explained with reference to the drawings.

(Configuration of Vehicle)

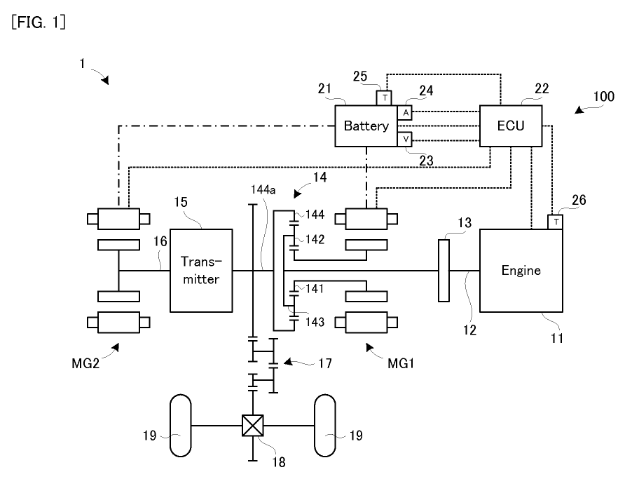

A configuration of a hybrid vehicle in the embodiment will be explained with reference to FIG. 1. FIG. 1 is a schematic diagram showing the configuration of the hybrid vehicle in the embodiment. Incidentally, FIG. 1 shows only members directly related to the present invention, and other materials are omitted as occasion demands.

In FIG. 1, a hybrid vehicle 1 is provided with: an engine 11; a triaxial power distributing mechanism 14 connected via a damper 13 to a crankshaft 12 as an output shaft of the engine 11; a motor generator MG1 connected to the power distributing mechanism 14 and capable of generating electricity; a motor generator MG2 connected to the power distributing mechanism 14 via a transmission 15; a battery 21 capable of supplying electric power to each of the motor generators MG1 and MG2 and capable of being charged by regenerative electric power of each of the motor generators MG1 and MG2; and an electronic control unit (ECU) 22.

The engine 11 is an internal combustion engine for outputting power by using fuel such as gasoline. The engine 11 is subject to operation control, such as fuel injection control, ignition control, and intake air adjustment control, by the ECU 22.

The power distributing mechanism 14 is provided with: a sun gear 141; a ring gear 144 disposed concentrically around the sun gear 141; a plurality of pinion gears 142 engaging with the sun gear 141 and engaging with the ring gear 144; and a carrier 143 for holding the plurality of pinion gears 142 so that the plurality of pinion gears 142 can rotate on their own axes and revolve around the carrier 143. In other words, the power distributing mechanism 14 is configured as a planetary gear mechanism for performing a differential action, with the sung gear 141, the ring gear 144, and the carrier 143 as rotational elements.

To the sun gear 141, the motor generator MG1 is connected. To the carrier 143, the crankshaft 12 of the engine 11 is connected via the damper 13. To the ring gear 144, the transmission 15 is connected via a ring gear shaft 144a.

When the motor generator MG1 functions as a generator, the power distributing mechanism 14 distributes the power from the engine 11 inputted via the carrier 143, to the sun gear 141 side and the ring gear 144 side, in accordance with its gear ratio.

On the other hand, when the motor generator MG1 functions as a motor, the power distributing mechanism 14 integrates the power from the engine 11 inputted via the carrier 143 and power from the motor generator MG1 inputted via the sun gear 141, and outputs the integrated power to the ring gear 144 side. The power outputted to the ring gear 144 is outputted from the ring gear shaft 144a via a gear mechanism 17 and a differential gear 18 to drive wheels 19.

The transmission 15 is configured to make a connection of a rotating shaft 16 of the motor generator MG2 with the ring gear shaft 144a and to release the connection.

Incidentally, the “motor generator MG1” in the embodiment is one example of the “motor” of the present invention.

(Cranking Torque Control Apparatus)

A cranking torque control apparatus 100 mounted on the hybrid vehicle 1 as configured above is provided with the ECU 22 which can estimate a fluctuation amount of power consumption caused by a rotational fluctuation of the engine 11 when the motor generator MG1 cranks the engine 11 and which can correct an upper limit of outputtable electric power of the battery 21 in accordance with the estimated fluctuation amount.

The cranking torque control apparatus 100 is further provided with: a voltage sensor 23 for detecting an inter-terminal voltage of the battery 21; a current sensor 24 for detecting an electric current inputted to or outputted from the battery 21; a temperature sensor 25 for detecting a temperature of the battery 21; and a temperature sensor 26 for detecting a temperature of the engine 11.

The “ECU 22” in the embodiment is one example of the “correcting device” of the present invention. In other words, in the embodiment, one portion of the functions of the ECU 22 for various electronic control of the hybrid vehicle 1 is used as one portion of the cranking torque control apparatus 100.

(Cranking Torque Control Processing)

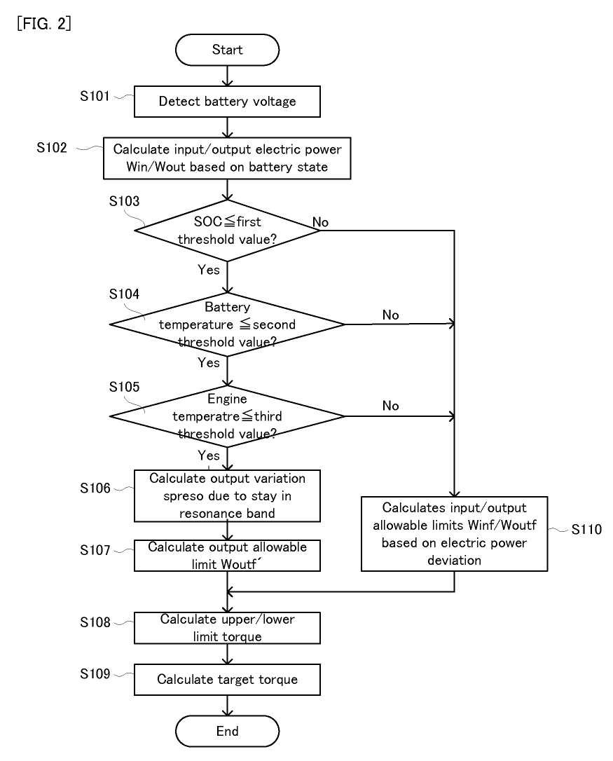

Cranking torque control processing performed by the cranking torque control apparatus 100 when the engine 11 is started (e.g. when the driving mode is moved from the EV driving mode to the HV driving mode, or in similar cases) will be explained with reference to a flowchart in FIG. 2. The cranking torque control processing is repeatedly performed at intervals of a predetermined time (e.g. at intervals of several msec (milliseconds)) when the engine 11 is started.

In FIG. 2, firstly, the ECU 22 as one portion of the cranking torque control apparatus 100 obtains the inter-terminal voltage of the battery 21 detected by the voltage sensor 23 (step S101).

Then, the ECU 22 calculates input/output electric power Win, Wout on the basis of the state of the battery 21 (step S102). Specifically, for example, the ECU 22 calculates the input/output electric power Win, Wout on the basis of state of charge (SOC) of the battery 21 specified by the obtained inter-terminal voltage of the battery 21, the temperature of the battery 21 detected by the temperature sensor 25, or the like. Incidentally, the SOC of the battery 21 may be specified by integrating values of the electric current detected by the current sensor 24.

Then, the ECU 22 judges whether or not an revolution of the engine 11 stays in a resonance band for a relatively long time due to the outputtable electric power of the battery 21. Specifically, the ECU 22 performs judgment processing in the following steps S103 to S105. Incidentally, any of the processing in the following steps S103 to S105 may be started first, regardless of the order described in FIG. 2.

The ECU 22 judges whether or not the SOC of the battery 21 is less than or equal to a first threshold value (step S103). Here, regarding the “first threshold value”, for example, a relation is obtained between the SOC of the battery and a time spent for the engine revolution to exceed the resonance band, experimentally, experientially, or by simulations, and the “first threshold value” may be set as the SOC of the battery such that the time spent until the engine revolution exceeds the resonance band is an upper limit of an allowable range on the basis of the obtained relation.

If it is judged that the SOC of the battery 21 is less than or equal to the first threshold value (the step S103: Yes), the ECU 22 judges whether or not the temperature of the battery 21 is less than or equal to a second threshold value (step S104). Here, regarding the “second threshold value”, for example, a relation is obtained among (i) the temperature of the battery, (ii) electric power that can be outputted by the battery, and (iii) the time spent for the engine revolution to exceed the resonance band, experimentally, experientially, or by simulations, and the “second threshold value” may be set as the temperature of the battery corresponding to the outputtable electric power such that the time spent until the engine revolution exceeds the resonance band is the upper limit of the allowable range on the basis of the obtained relation.

If it is judged that the temperature of the battery 21 is less than or equal to the second threshold value (the step S104: Yes), the ECU 22 judges whether or not an engine temperature (here, the temperature of the engine 11 detected by the temperature sensor 26) is less than or equal to a third threshold value (step S105). Here, regarding the “third threshold value”, for example, a relation is obtained among (i) the engine temperature, (ii) friction associated with the engine, and (iii) the time spent for the engine revolution to exceed the resonance band, experimentally, experientially, or by simulations, and the “third threshold value” may be set as the engine temperature corresponding to the friction r such that the time spent until the engine revolution exceeds the resonance band is the upper limit of the allowable range on the basis of the obtained relation.

If it is judged that the engine temperature is less than or equal to the third threshold value (i.e. if all the results of the judgment processing in the steps S103 to S105 are “Yes”) (the step S105: Yes), the ECU 22 judges that the revolution of the engine 11 stays in the resonance band for a relatively long time due to the outputtable electric power of the battery 21. Then, the ECU 22 calculates an output variation spreso of the battery 21 due to the stay of the revolution of the engine 11 in the resonance band (step S106).

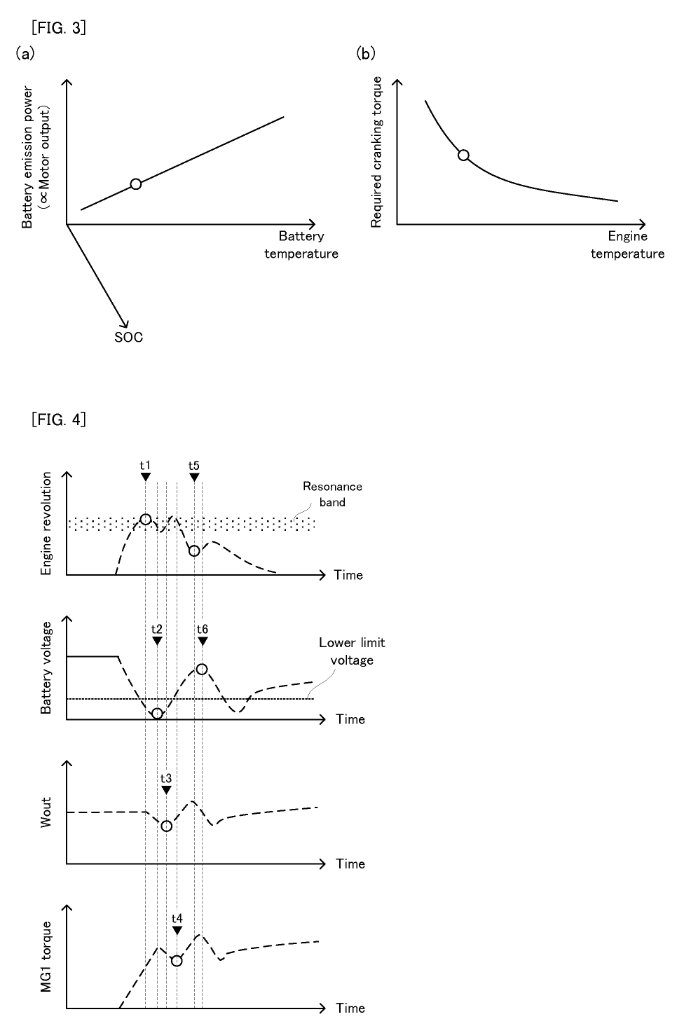

Here, one specific example of a method of calculating the output variation spreso will be explained with reference to FIG. 3. FIG. 3(a) shows one example of a relation among the SOC of the battery, the battery temperature, and the outputtable electric power, and FIG. 3(b) shows a relation between the engine temperature and required cranking torque. Incidentally, the ECU 22 as one portion of the cranking torque control apparatus 100 stores the relations shown in FIG. 3(a) and FIG. 3(b) as a map in advance.

The ECU 22 specifies the outputtable electric power of the battery 21 (proportional to output torque of the motor generator MG1) on the basis of the SOC of the battery 21 and the temperature of the battery 21. The ECU 22 further specifies the required cranking torque on the basis of the temperature of the engine 11.

Then, the ECU 22 specifies a target cranking revolution in view of balance between the specified required cranking torque and the specified outputtable electric power corresponding to the output torque of the motor generator MG1.

If the specified target cranking revolution falls into the resonance band, the ECU 22 calculates the output variation spreso as one example of the “fluctuation amount of power consumption caused by a rotational fluctuation of the engine” according to the present invention, for example, by using the following equation.

Output variation spreso=(Variation upper limit revolution−Variation lower limit revolution)×Torque×Circumference ratio×2

Incidentally, it has been found by the studies of the present inventors that the “variable upper limit revolution” and the “variation lower limit revolution” depend on the structure of a power transmission system of the hybrid vehicle 1 and thus can be predicted in the design phase.

Again, back in FIG. 2, the ECU 22 calculates an output allowable limit Woutf' on the basis of the output electric power Wout calculated in the processing in the step S102 and the output variation spreso calculated in the processing in the step S106 (step S107). Specifically, for example, the ECU 22 calculates the output allowable limit Woutf' by subtracting the output variation spreso from the output electric power Wout.

Then, the ECU 22 calculates upper limit output torque (i.e. torque corresponding to the output allowable limit Woutf') and lower limit output torque on the basis of the calculated output allowable limit Woutf' (step S108). Then, the ECU 22 calculates target torque within a range of the upper limit output torque and the lower limit output torque (step S109).

On the other hand, if any of the judgment processing in the steps S103 to S105 described above is “No” (i.e. if it is judged (i) that the SOC of the battery 21 is greater than the first threshold value, (ii) that the temperature of the battery 21 is greater than the second threshold value, or (iii) that the engine temperature is greater than the third threshold value), the ECU 22 judges that the revolution of the engine 11 does not stay in the resonance band. Then, the ECU 22 calculates input/output allowable limits Winf, Woutf on the basis of an electric power deviation (i.e. power consumption according to the revolution of the engine 11 and the torque of the motor generator MG1 before a predetermined time) (step S110).

Incidentally, a method of calculating the input/output allowable limits Winf, Woutf can adopt various known aspects, and thus, the explanation thereof will be omitted herein.

Then, the ECU 22 calculates the upper limit output torque and the lower limit output torque on the basis of the calculated input/output allowable limits Winf, Woutf (step S108) and calculates the target torque (the step S109).

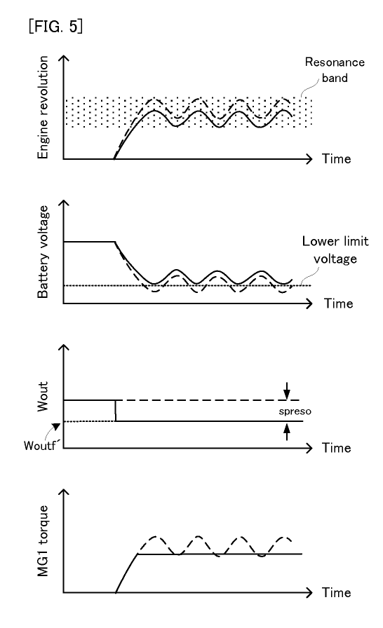

Next, the effect of the cranking torque control apparatus 100 will be explained with reference to FIG. 4 and FIG. 5. FIG. 4 shows one example of a time variation such as the engine revolution in a comparative example. FIG. 5 shows one example of the time variation such as the engine revolution in the embodiment.

The operation of a cranking torque control apparatus in the comparative example of the embodiment will be explained with reference to FIG. 4. Here, the cranking torque control apparatus in the comparative example performs only output limitation of the battery 21 based on the electric power deviation.

In FIG. 4, it is assumed that the revolution of the engine 11 increases, for example, due to resonance, at a time point t1 (refer to the top of FIG. 4). Then, at a time point t2 which is a predetermined time behind the time point t1, the inter-terminal voltage of the battery 21 falls below a lower limit voltage because a revolution of the motor generator MG1 increases with increasing the revolution of the engine 11 (refer to the second graph from the top of FIG. 4).

Thus, the ECU 22 tightens the output limitation of the battery 21 at a time point t3 from the viewpoint of the protection of the battery 21 (refer to the second graph from the bottom of FIG. 4). Then, at a time point t4 which is a predetermined time behind the time point t3, the cranking torque of the motor generator MG1 decreases (refer to the bottom of FIG. 4).

As a result, the support torque by the motor generator MG1 decreases, which reduces the revolution of the engine 11 (refer to the top of FIG. 4, at a time point t5). Due to the reduction in the revolution of the engine 11, the inter-terminal voltage of the battery 21 becomes larger than the lower limit voltage (refer to the second graph from the top of FIG. 4, at a time point t6), but the engine 11 stalls.

On the other hand, in the cranking torque control apparatus 100 in the embodiment, if it is predicted that the revolution of the engine 11 stays in the resonance band at the start of the engine 11, as described above, the value obtained by subtracting only the output variation spreso from the output electric power Wout (i.e. the output allowable limit Woutf') is set as an upper limit output.

In other words, in the embodiment, as shown in the second graph from the bottom of FIG. 5, the value obtained by subtracting only the output variation spreso, which is the variation of the electric power due to the rotational fluctuation of the engine 11 caused by the resonance or the like, from the upper limit of the original output electric power (refer to a dashed line on the second graph from the bottom of FIG. 5) is set as the upper limit output (refer to a solid line on the second graph from the bottom of FIG. 5).

Thus, even if the revolution of the engine 11 varies in the resonance band (refer to a solid line on the top of FIG. 5), it is possible to prevent the inter-terminal voltage of the battery 21 from falling below the lower limit voltage (refer to a solid line on the second graph from the top of FIG. 5). In addition, it is possible to suppress a change in the cranking torque of the motor generator MG1 (refer to a solid line on the bottom of FIG. 5).

As a result, according to the cranking torque control apparatus 100 in the embodiment, it is possible to suppress the occurrence of the unexpected engine stall while preventing the inter-terminal voltage of the battery 21 from falling below the lower limit voltage of the battery 21.

Incidentally, the dashed line in FIG. 5 shows the time variation such as the engine revolution in the comparative example.

The present invention is not limited to the aforementioned embodiment, but various changes may be made, if desired, without departing from the essence or spirit of the invention which can be read from the claims and the entire specification. A cranking torque control apparatus, which involves such changes, is also intended to be within the technical scope of the present invention.

### DESCRIPTION OF REFERENCE CODES

1 hybrid vehicle
11 engine
14 power distributing mechanism
15 transmission
21 battery
22 ECU

1. A cranking torque control apparatus mounted on a hybrid vehicle comprising: an engine; a motor coupled with the engine and capable of cranking the engine; and a battery capable of supplying electric power to the motor, said cranking torque control apparatus comprising:
a correcting device for estimating a fluctuation amount of power consumption caused by a rotational fluctuation of the engine in a resonance band associated with the hybrid vehicle when the motor cranks the engine and for correcting an upper limit of outputtable electric power of the battery in accordance with the estimated fluctuation amount.
